(19) United States
(12) Patent Application Publication
(10) Pub. No.: US 2026/0268271 A1
(43) Pub. Date: Sep. 10, 2026

(54) DELIVERY MANAGEMENT SYSTEM, STORAGE MEDIUM STORING DELIVERY MANAGEMENT PROGRAM, AND DELIVERY MANAGEMENT METHOD

(71) Applicant: CANON KABUSHIKI KAISHA, Tokyo (JP)

(72) Inventor: YUKI SUETANI, Tokyo (JP)

(21) Appl. No.: 19/547,937

(22) Filed: Feb. 24, 2026

(30) Foreign Application Priority Data
Mar. 4, 2025 (JP) 2025-033567

(51) Int. Cl. G06Q 10/087

(52) U.S. Cl. CPC G06Q 10/08726

(57) ABSTRACT

A delivery management system capable of improving efficiency of delivery management of consumables. The delivery management system includes image processing apparatuses using consumables and a server that holds a first threshold and a larger second threshold provided for each of the apparatuses and communicates with the apparatuses. The server generates first information indicating a first image processing apparatus and its first consumable when a remaining amount of the first consumable becomes less than the first threshold for the first image processing apparatus, generates second information indicating a second image processing apparatus and its second consumable when the first information is generated and a remaining amount of the second consumable becomes less than the second threshold for the second image processing apparatus, and instructs delivery of the first and second consumables by using the first and second information. At least one of the first thresholds and the second thresholds are different.

### BACKGROUND

### Field of the Technology

The aspect of the embodiments relates to a delivery management system, a storage medium storing a delivery management program, and a delivery management method.

### Description of the Related Art

Conventionally, a flat-rate consumables service and an all-inclusive flat-rate service are known as subscription services. The flat-rate consumables service enables a service subscriber to use consumables used for printing in an image processing apparatus at a flat rate. In the all-inclusive flat-rate service, a service provider provides an image processing apparatus at a flat rate in addition to consumables. In these services, when a remaining amount of consumable used in an image processing apparatus is insufficient or reduced, dedicated consumable is delivered to a service subscriber.

A related technique is disclosed in, for example, Japanese Patent Laid-Open No. 2019-200334 (JP2019-200334A, Counterpart of US20190354325A1). In the technique described in this publication, when a consumable used in an image processing apparatus reaches a first threshold of a replacement time, if a consumable used in another image processing apparatus reaches another threshold (second threshold), the consumable that has reached the first threshold and the consumable that has reached the second threshold are collectively delivered. This improves an efficiency of consumable replacement for a plurality of image processing apparatuses.

However, the technique described in the above publication is based on the premise that the first threshold and second threshold are common among a plurality of image processing apparatuses even if the models or series are different. That is, the technique described in the above publication does not consider a case where there is an image processing apparatus whose threshold is different from the first and second thresholds is provided among a plurality of image processing apparatuses. In this regard, since the subscription service is applicable to a combination of different models or series, in a case where image processing apparatuses in different ranges are introduced, the image processing apparatuses may be different in a printing speed, the number of sheets printed at a time, types of consumables, and the like. Therefore, since a situation in which the consumption speed of the consumable and the threshold related to the replacement time of the consumables are different for each image processing apparatus is assumed, there is a problem that it is necessary to manage the delivery of a plurality of consumables in consideration of such a situation.

### SUMMARY

The present disclosure provides a mechanism capable of improving the efficiency of the delivery management of consumables for a plurality of image processing apparatuses.

Accordingly, an aspect of the embodiments provides a delivery management system including a plurality of image processing apparatuses using consumables, and a server that holds a first threshold and a second threshold larger than the first threshold provided for each of the plurality of image processing apparatuses and is capable of communicating with the plurality of image processing apparatuses. The server includes a first generation unit configured to generate first information indicating a first image processing apparatus among the plurality of image processing apparatuses and a first consumable used in the first image processing apparatus in a case where a remaining amount of the first consumable becomes equal to or less than the first threshold provided for the first image processing apparatus, a second generation unit configured to generate second information indicating a second image processing apparatus among the plurality of image processing apparatuses and a second consumable used in the second image processing apparatus in a case where the first information is generated and a remaining amount of the second consumable becomes equal to or less than the second threshold provided for the second image processing apparatus, and an instruction unit configured to instruct delivery of the first consumable and the second consumable by using the first information and the second information. At least one of the first thresholds and the second thresholds are different among the plurality of image processing apparatuses.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a consumable delivery management system.

FIG. 2 is a hardware block diagram of an image processing apparatus.

FIG. 3 is a hardware block diagram of a server that is implemented with a general information processing apparatus.

FIG. 4 is a hardware block diagram of a host terminal that is implemented with a general information processing apparatus.

FIG. 5 is a software block diagram of the image processing apparatus.

FIG. 6 is a software block diagram of the server.

FIG. 7 is a flowchart illustrating an operation when the server performs delivery management of consumables in a first embodiment.

FIG. 8A, FIG. 8B, and FIG. 8C are diagrams for describing specific examples of the delivery management of consumables.

FIG. 9 is a flowchart illustrating an operation when the server performs delivery management of consumables in a second embodiment.

FIG. 10 shows an example of a selection screen to prompt an administrator who maintains a plurality of image processing apparatuses that are subjected to a subscription contract to select whether to allow delivery of consumables.

FIG. 11 is a flowchart illustrating an operation when the host terminal displays the selection screen.

### DESCRIPTION OF THE EMBODIMENTS

Hereinafter, embodiments of the present disclosure will be described in detail with reference to the drawings. However, configurations described in the following embodiments are merely examples, and the scope of the present disclosure is not limited by the configurations described in the embodiments. For example, each unit constituting the present disclosure can be replaced with any configuration capable of exhibiting the same function. In addition, an arbitrary constituent may be added. Any two or more configurations (features) of the embodiments can be combined. The same reference numerals are given to the same configurations and processes and duplicated descriptions thereof will be omitted.

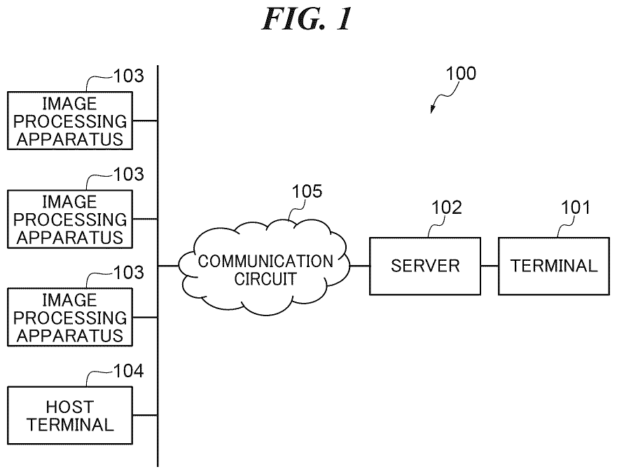

Hereinafter, a first embodiment will be described with reference to FIG. 1 to FIG. 8C. FIG. 1 is a block diagram illustrating a consumable delivery management system 100. As illustrated in FIG. 1, in the consumable delivery management system 100, a terminal 101 and a server 102 are mutually connected, and the server 102, a plurality of image processing apparatuses 103, and a host terminal 104 are mutually connected via a communication line 105. The terminal 101 is a smartphone, a computer, or the like operated or viewed by a person who manages or operates a subscription service. A person who manages or operates the subscription service instructs to deliver consumables to each of the plurality of image processing apparatuses 103 that are subjected to a subscription contract. The image processing apparatuses 103 can use a part or all of printing, scanning, and faxing functions.

The host terminal 104 is a smartphone, a computer, or the like operated by an administrator who maintains the plurality of image processing apparatuses 103 that are subjected to the subscription contract. The plurality of image processing apparatuses 103 and the host terminal 104 can always communicate with the server 102 via the communication line 105. The terminal 101 can also always communicate with the server 102. The server 102 can collect information from each of the plurality of image processing apparatuses 103 to monitor the plurality of image processing apparatuses 103, and can receive a request from the terminal 101 to perform a process.

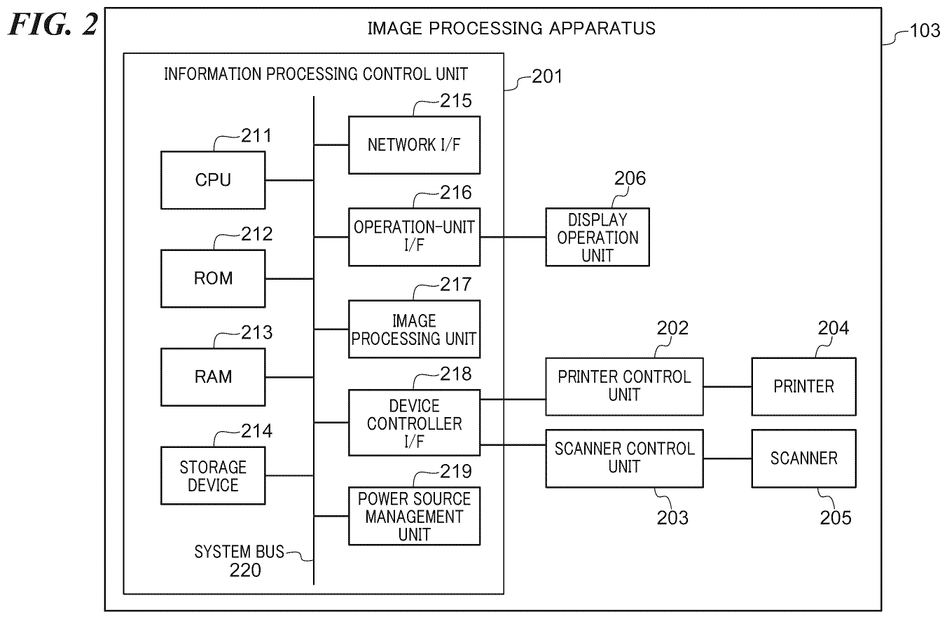

FIG. 2 is a hardware block diagram of the image processing apparatus 103. The image processing apparatus 103 has an information processing control unit 201, a printer control unit 202, a scanner control unit 203, a printer 204, a scanner 205, and a display operation unit 206. The information processing control unit 201 is a controller that integrates information processing control related to the operation of the image processing apparatus 103, and is connected to the display operation unit 206. Further, the information processing control unit 201 is connected to the printer control unit 202 that controls the printer 204 that is an image output device and the scanner control unit 203 that controls the scanner 205 that is an image input device.

The information processing control unit 201 has a CPU 211, a ROM 212, a RAM 213, and a storage device 214. The CPU 211 starts an OS by a boot program stored in the ROM 212. The CPU 211 executes various processes of the image processing apparatus 103 by executing application programs stored in the storage device 214 on the OS. At this time, the RAM 213 is used as a work area of the CPU 211. The RAM 213 provides the work area and an image memory area for temporarily storing image data. An application program stored in a storage medium may be read and installed in the storage device 214 by the CPU 211. The storage device 214 stores data such as various setting values and history in addition to the above application programs and image data.

The ROM 212, the RAM 213, the storage device 214, a network I/F 215, an operation-unit I/F 216, an image processing unit 217, a device controller I/F 218, and a power source management unit 219 are connected to the CPU 211 via a system bus 220. The network I/F 215 is connected to the communication line 105 to input and output information to and from each apparatus on the communication line 105. The operation-unit I/F 216 is an interface with the display operation unit 206 having a touch panel, a numeric keypad, and the like, and outputs image data to the display operation unit 206 to be displayed. The operation-unit I/F 216 transfers information input through the display operation unit 206 by a user to the CPU 211.

The image processing unit 217 performs various processes, such as an image output process to output image data to the printer 204, an image input process to input image data from the scanner 205, an image rotation process, an image compression process, a resolution conversion process, a color space conversion process, and a gradation conversion process. The printer control unit 202 and the scanner control unit 203 are connected to the device controller I/F 218. The device controller I/F 218 performs conversion between a synchronous system and a non-synchronous system of image data. The power source management unit 219 controls the power supply of the entire apparatus, controls on/off of the power supply, and controls transition to a power saving state other than a normal energized state, return to the normal energized state, and the like.

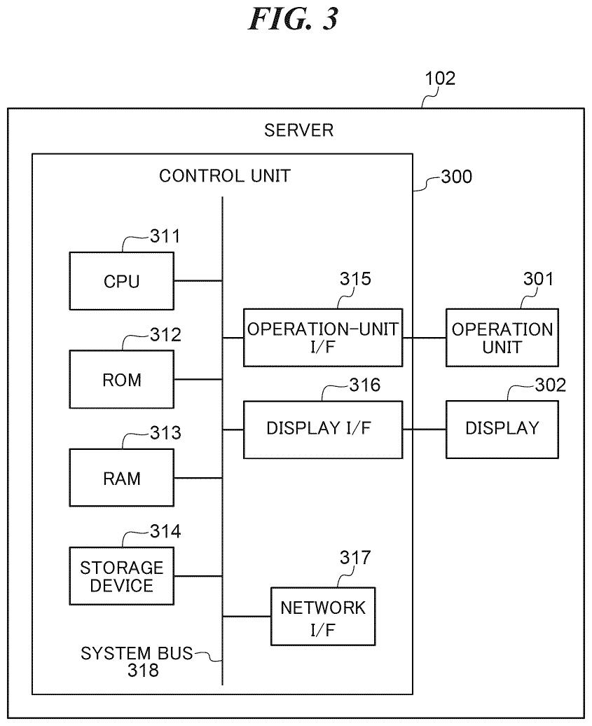

FIG. 3 is a hardware block diagram of the server 102 that is implemented with a general information processing apparatus. The server 102 is mainly configured by a control unit 300, an operation unit 301, and a display 302. The control unit 300 include a CPU 311, a ROM 312, a RAM 313, and a storage device 314. The CPU 311 starts an OS by a boot program stored in the ROM 312. The CPU 311 executes various processes of the server 102 by executing application programs stored in the storage device 314 on the OS. At this time, the RAM 313 is used as a work area of the CPU 311. An application program stored in a storage medium may be read and installed in the storage device 314 by the CPU 311. The storage device 314 stores data such as various setting values and history in addition to the above application programs.

The ROM 312, the RAM 313, a storage device 314, an operation-unit I/F 315, a display I/F 316, and a network I/F 317 are connected to the CPU 311 via a system bus 318. The operation-unit I/F 315 is an interface with the operation unit 301 having a touch panel, a keyboard, a mouse, and the like, and transfers information input through the operation unit 301 by the user to the CPU 311. The display I/F 316 outputs image data to the display 302 to be displayed. The network I/F 317 is connected to the communication line 105 to input and output information to and from each apparatus on the communication line 105.

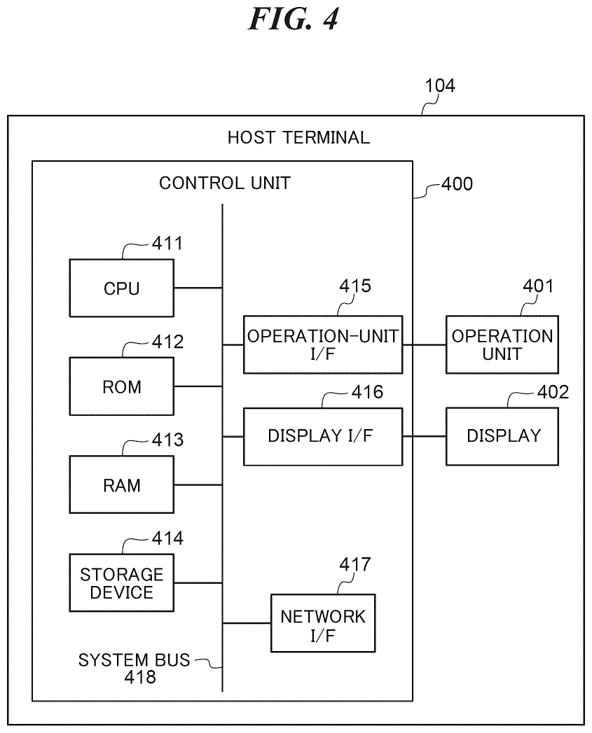

FIG. 4 is a hardware block diagram of the host terminal 104 that is implemented with a general information processing apparatus. The host terminal 104 is not significantly different from the server 102 in the main configuration. Therefore, the hardware components of the host terminal 104 illustrated in FIG. 4 that correspond to the hardware components of the server 102 are denoted by changing the reference numerals in the 300s to reference numerals in the 400s and the detailed description thereof will be omitted. Although not shown, the hardware configuration of the terminal 101 is the same as that of the host terminal 104.

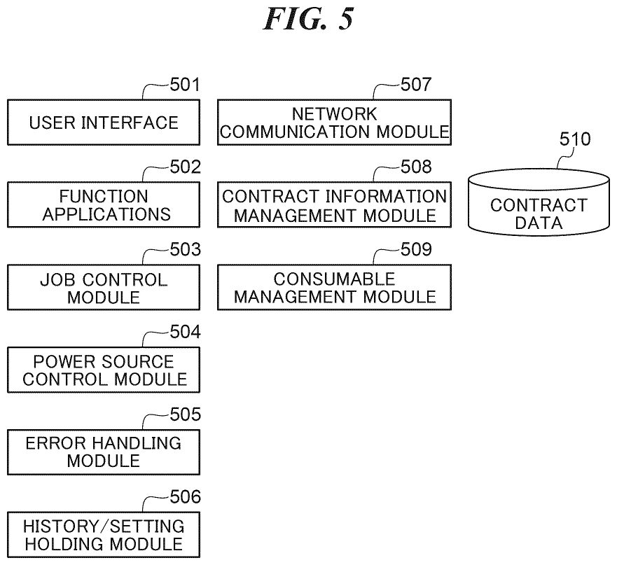

FIG. 5 is a software block diagram of the image processing apparatus 103. The image processing apparatus 103 includes a user interface 501, a function application 502, a job control module 503, a power source control module 504, an error handling module 505, a history/setting holding module 506, a network communication module 507, a contract information management module 508, and a consumable management module 509. Further, the image processing apparatus 103 has contract data 510. These software components are stored in any of the RAM 213, storage device 214, and ROM 212 in the information processing control unit 201 of the image processing apparatus 103 and are executed by the CPU 211. Accordingly, the image processing apparatus 103 achieves a scan function, a print function, and various functions using the network, memory, and storage device by operating the corresponding software components.

The user interface 501 has a function of displaying a screen operated by the user on the display operation unit 206 and transferring a motion of a user operation to the software. The function applications 502 are dedicated to the respective functions such as copying, printing, and mail transmission. The function applications 502 operate application functions of the image processing apparatus 103 with an instruction of the user via the display operation unit 206, reception of data via the network I/F 215, or the like as a trigger. The job control module 503 controls the printer control unit 202 and the scanner control unit 203 to execute printing and scanning when receiving instructions from the function applications 502. The power source control module 504 controls the power source management unit 219 in conjunction with the state of the software in the apparatus, and manages transition between the normal energized state and the power saving state.

The error handling module 505 mainly receives a notification of an abnormal state that has occurred in the job control module 503, the printer control unit 202, the scanner control unit 203, or the like, and stops the operation of the entire apparatus or instructs a degeneration operation. The history/setting holding module 506 manages nonvolatile information in the apparatus. The history/setting holding module 506 stores settings necessary to control the image processing apparatus 103 and a job, and summarizes and stores a history of operations by a user, a job execution result, an occurrence of an error, and the like. In addition, the history/setting holding module 506 stores log information for analysis debugging when a system failure occurs. The network communication module 507 communicates with the host terminal 104 and the server 102 connected to the image processing apparatus 103 via the communication line 105. The network communication module 507 receives a copy/scan execution request or an import request from each apparatus on the communication line 105, and instructs the function applications 502 to execute a job.

The contract information management module 508 manages subscription contract information obtained from the server 102 via the network communication module 507. The contract information management module 508 stores the subscription contract information in the contract data 510. The consumable management module 509 manages information (hereinafter, referred to as “consumable status information”) indicating a consumable status obtained from the printer control unit 202. The consumable management module 509 notifies the server 102 of the consumable status information at a certain frequency via the network communication module 507.

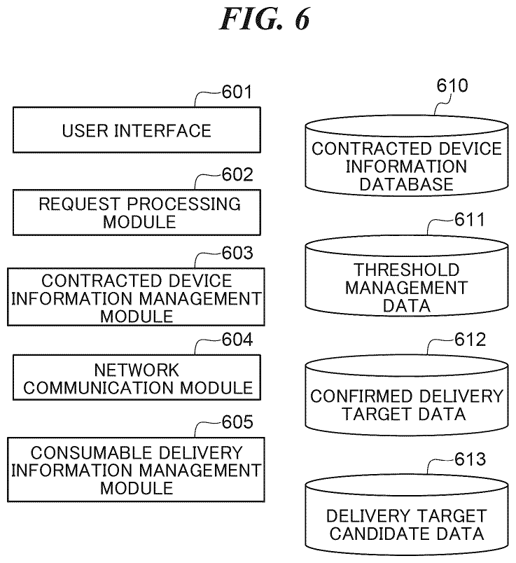

FIG. 6 is a software block diagram of the server 102. The server 102 includes a user interface 601, a request processing module 602, a contracted device information management module 603, a network communication module 604, and a consumable delivery information management module 605. The server 102 further includes a contracted device information database 610, threshold management data 611, confirmed delivery target data 612, and delivery target candidate data 613. These software components are stored in any of the RAM 313, storage device 314, and ROM 312 and are executed by the CPU 311. The user interface 601 has a function of displaying an operation screen on the display 302 and transmitting a motion of an operation using the operation unit 301 to the software. The request processing module 602 has a function of processing a processing request received by the network communication module 604 from the plurality of image processing apparatuses 103 and the host terminal 104 via the communication line 105. The request processing module 602 also has a function of processing a processing request received from the terminal 101.

The contracted device information management module 603 registers and manages the information about the subscription contract made by the user, that is, the subscription contract information in the contracted device information database 610. The user performs the procedure of the subscription contract according to guidance displayed on the display 402 of the host terminal 104. Alternatively, the user may perform the procedure of the subscription contract according to guidance displayed on the display operation unit 206 of the image processing apparatus 103. The contracted device information management module 603 obtains contents of the procedure of the subscription contract as the subscription contract information via the communication line 105 and registers the contents in the contracted device information database 610. The consumable delivery information management module 605 manages delivery of a new consumable for replacement to the user based on the consumable status information from the consumable management module 509 of the image processing apparatus 103. For example, when the consumable delivery information management module 605 receives the consumable status information from the consumable management module 509 of the image processing apparatus 103, the consumable delivery information management module 605 determines whether the remaining amount of the consumable reaches a predetermined threshold based on the information held in the threshold management data 611.

As shown in the following table 1, the threshold management data 611 holds, for each device that is a target of the subscription contract, a capacity of a consumable, a first threshold indicating that replacement time of the consumable has been reached, and a second threshold indicating that the replacement time of the consumable is expected to be reached soon. The devices respectively correspond to the plurality of image processing apparatuses 103. In addition, the types of consumables of the devices may be all the same, some may be different, or all may be different. The consumables include, for example, sheet, ink, toner, and the like.

TABLE 1

| Device | Capacity | First Threshold | Second Threshold |
|---|---|---|---|
| A | 100 | 20(A1) | 30(A2) |
| B | 500 | 100(B1) | 130(B2) |
| C | 1000 | 200(C1) | 300(C2) |
| . . . | . . . | . . . | . . . |

The table 1 shows that the capacity of the consumable of the device A is 100, the first threshold (A1) of the device A is 20, and the second threshold (A2) of the device A is 30. The table 1 also shows that the capacity of the consumable of the device B is 500, the first threshold (B1) of the device B is 100, and the second threshold (B2) of the device B is 130. Further, the table 1 shows that the capacity of the consumable of the device C is 1000, the first threshold (C1) of the device C is 200, and the second threshold (C2) of the device C is 300.

Although the table 1 shows the first thresholds and the second thresholds in actual numbers for the different capacities of the consumables, respectively, the first thresholds and the second thresholds may be represented by percentages. Although the capacities of the consumables are different from each other in the table 1, some of the capacities may be identical or all of the capacities may be identical. The table 1 also shows all of the first thresholds and the second thresholds as different values. In this regard, although it is necessary to make a second threshold larger than a first threshold for each device, the present disclosure is applicable even when the first thresholds and the second thresholds are partially different between devices. For example, there is a case where the A1, B1, and C1 have the same value, any two of the A2, B2, and C2 have the same value, and the other one has a value different from the value of the two.

When the remaining amount of the consumable becomes equal to or less than a predetermined threshold and it is determined that the consumable needs to be replaced or the consumable needs to be replaced soon, the necessity of delivery of a new consumable is displayed on the display 302 of the server 102 and a notification is issued to the terminal 101. When there is a consumable whose remaining amount is equal to or less than the first threshold in each device, the consumable delivery information management module 605 generates first consumable delivery target information indicating the consumable and the device using the consumable concerned, and stores the first consumable delivery target information in the confirmed delivery target data 612. In addition, when there is a consumable whose remaining amount is equal to or less than the second threshold in each device, the consumable delivery information management module 605 generates second consumable delivery target information indicating the consumable and the device using the consumable concerned, and stores the second consumable delivery target information in the delivery target candidate data 613.

Next, a subscription contract assumed in the first embodiment will be described. The subscription contract enables printing at a monthly fixed fee without purchasing an apparatus itself. In addition, the subscription contract allows to introduce a plurality of devices, and assumes a combination of devices having different models or series, that is, a combination of devices in different ranges. As a specific flow until the service of the subscription contract is started, a user first accesses the URL for contract of the server 102 from the browser of the host terminal 104 or the like.

When the server 102 confirms that information necessary for the subscription contract, for example, a contractor name, a consumable delivery destination address, a payment method of the fee, and the like are correctly input by a user, the server 102 notifies the host terminal 104 of a contract completion notification. Thereafter, when the subscription contract is concluded, the server 102 transmits the subscription contract information to the image processing apparatus 103 of the contract target and stores the subscription contract information in the contracted device information database 610. As a result, the subscription contract is registered, and provision of various services under the subscription contract is started.

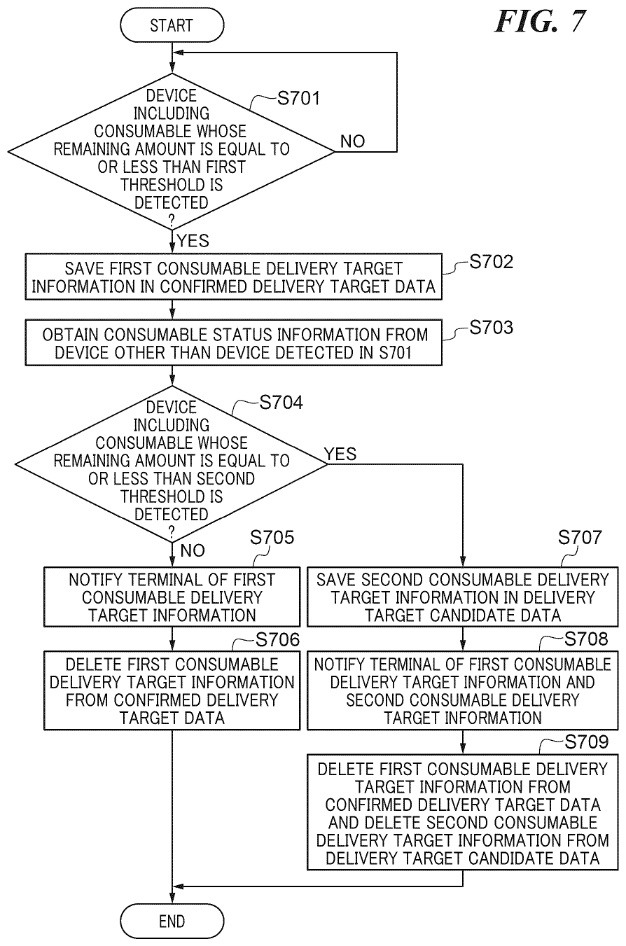

FIG. 7 is a flowchart illustrating an operation when the server 102 performs delivery management of consumables in the first embodiment. The flowchart (method) in FIG. 7 is achieved by the CPU 311 in the server 102 loading a program read from the storage device 314 onto the RAM 313 and executing the program. The following description will be made with reference to the table 1. Further, the description will be made using the device A, device B, and device C as the plurality of image processing apparatuses 103.

In a step S701, the CPU 311 determines whether the consumable delivery information management module 605 detects a device including a consumable whose remaining amount is equal to or less than the first threshold. This determination is performed based on consumable status information sent from each device to the server 102 at the certain frequency. Further, the first threshold indicates that the replacement time of the consumable has been reached and corresponds to A1 for the device A, B1 for the device B, and C1 for the device C in the table 1. When the CPU 311 determines that the consumable delivery information management module 605 detects no device including a consumable whose remaining amount is equal to or less than the first threshold, the determination in the step S701 is repeated. In contrast, when the CPU 311 determines that the consumable delivery information management module 605 detects a device including a consumable whose remaining amount is equal to or less than the first threshold, the process proceeds to a step S702.

In the step S702, the CPU 311 (a first generation unit) generates and saves the first consumable delivery target information indicating the consumable whose remaining amount is equal to or less than the first threshold and the device including the consumable concerned by the consumable delivery information management module 605 (a first generation step). The first consumable delivery target information (first information) indicating the consumable (a first consumable) whose remaining amount is equal to or less than the first threshold and the device (a first image processing apparatus) including the consumable concerned is saved in the confirmed delivery target data 612. In a step S703, the CPU 311 obtains, with the network communication module 604, the consumable status information from a device other than the device detected in the step S701.

In a step S704, the CPU 311 determines whether the consumable delivery information management module 605 detects a device including a consumable whose remaining amount is equal to or less than the second threshold. This determination is performed based on the consumable status information that is the basis of the determination in the step S701 and the consumable status information obtained in the step S703. Accordingly, the consumable statuses of all devices subjected to the subscription contract can be checked. Further, the second threshold indicates that the replacement time of the consumable is expected to be reached soon and corresponds to A2 for the device A, B2 for the device B, and C2 for the device C in the table 1. When the CPU 311 determines that the consumable delivery information management module 605 detects the device including the consumable whose remaining amount is equal to or less than the second threshold, the process proceeds to a step S707 described later. In contrast, when the CPU 311 determines that the consumable delivery information management module 605 detects no device including a consumable whose remaining amount is equal to or less than the second threshold, the process proceeds to a step S705.

In the step S705, the CPU 311 notifies, with the network communication module 604, the terminal 101 of the first consumable delivery target information saved in the confirmed delivery target data 612. Accordingly, in the terminal 101, the delivery of the consumable in the subscription contract is instructed based on the first consumable delivery target information. In a step S706, the CPU 311 deletes, with the consumable delivery information management module 605, the first consumable delivery target information saved in the confirmed delivery target data 612. Thereafter, the flowchart in FIG. 7 ends.

In a step S707, the CPU 311 (a second generation unit) generates and saves the second consumable delivery target information indicating the consumable whose remaining amount is equal to or less than the second threshold and the device including the consumable concerned by the consumable delivery information management module 605 (a second generation step). The second consumable delivery target information (second information) indicating the consumable (second consumable) whose remaining amount is equal to or less than the second threshold and the device (second image processing apparatus) including the consumable concerned is saved in the delivery target candidate data 613.

In a step S708, the CPU 311 (an instruction unit) notifies, with the network communication module 604, the terminal 101 of the first consumable delivery target information saved in the confirmed delivery target data 612 and the second consumable delivery target information saved in the delivery target candidate data 613 (an instruction step). Accordingly, in the terminal 101, the delivery of the consumable in the subscription contract is instructed based on the first consumable delivery target information and the second consumable delivery target information. In a step S709, the CPU 311 deletes, with the consumable delivery information management module 605, the first consumable delivery target information saved in the confirmed delivery target data 612 and the second consumable delivery target information saved in the delivery target candidate data 613. Thereafter, the flowchart in FIG. 7 ends.

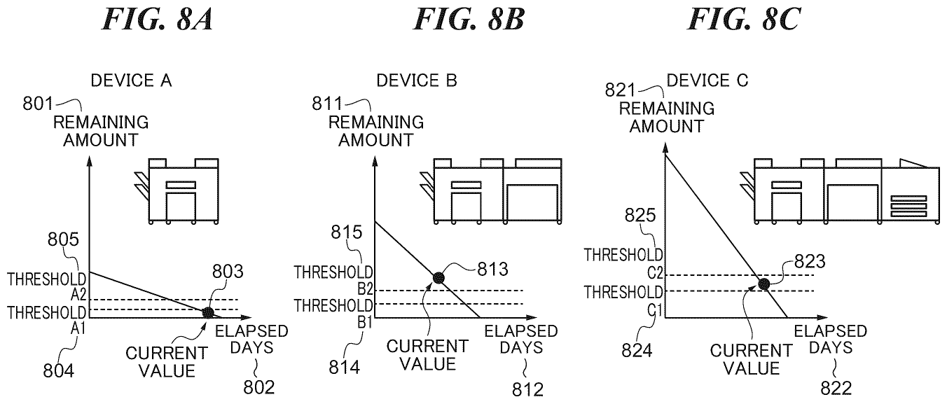

FIG. 8A, FIG. 8B, and FIG. 8C are diagrams for describing specific examples of the delivery management of consumables. In FIG. 8A, the remaining amount of the consumable of the device A is approximately indicated by a linear graph. A vertical axis 801 indicates the remaining amount, and a horizontal axis 802 indicates elapsed days. A current value 803 indicates the remaining amount at the present time. The current value 803 of the remaining amount of the consumable of the device A is less than the thresholds A1 804 and A2 805. Accordingly, the device A is a device including a consumable whose remaining amount is less than the first threshold (YES in the step S701). Therefore, the first consumable delivery target information indicating the device A and the consumable of the device A is generated and saved in the confirmed delivery target data 612 (the step S702). Accordingly, the consumable of the device A becomes a delivery target as a consumable that has reached the replacement time (the steps S705 and S708).

In FIG. 8B, the remaining amount of the consumable of the device B is approximately indicated by a linear graph. A vertical axis 811 indicates the remaining amount, and a horizontal axis 812 indicates elapsed days. A current value 813 indicates the remaining amount at the present time. The current value 813 of the remaining amount of the consumable of the device B is more than the thresholds B2 815 and B1 814. Therefore, the device B is not a device including a consumable whose remaining amount is equal to or less than the first threshold and is not a device including a consumable whose remaining amount is equal to or less than the second threshold. Therefore, the first consumable delivery target information and the second consumable delivery target information indicating the device B and the consumable of the device B are not generated and are not saved in the confirmed delivery target data 612 and the delivery target candidate data 613. Accordingly, the consumable of the device B does not become a delivery target.

In FIG. 8C, the remaining amount of the consumable of the device C is approximately indicated by a linear graph. A vertical axis 821 indicates the remaining amount, and a horizontal axis 822 indicates elapsed days. A current value 823 indicates the remaining amount at the present time. The current value 823 of the remaining amount of the consumable of the device C is more than the threshold C1 824 and but is less than the threshold C2 825. Accordingly, the device C is not a device including a consumable whose remaining amount is less than the first threshold, but is a device including a consumable whose remaining amount is less than the second threshold (YES in the step S704). Therefore, the second consumable delivery target information indicating the device C and the consumable of the device C is generated and saved in the delivery target candidate data 613 (the step S707). Accordingly, the consumable of the device C becomes a delivery target as a consumable that is expected to be reached the replacement time soon (the step S708).

As described above, the consumable delivery management system 100 enables the delivery management of the consumable even in a case where the threshold related to the replacement time of the consumable, which is different from that of the other image processing apparatus 103, is provided in the plurality of image processing apparatuses 103 subjected to the subscription contract. Accordingly, the consumable delivery management system 100 can improve the efficiency of the consumable delivery management for the plurality of image processing apparatuses 103.

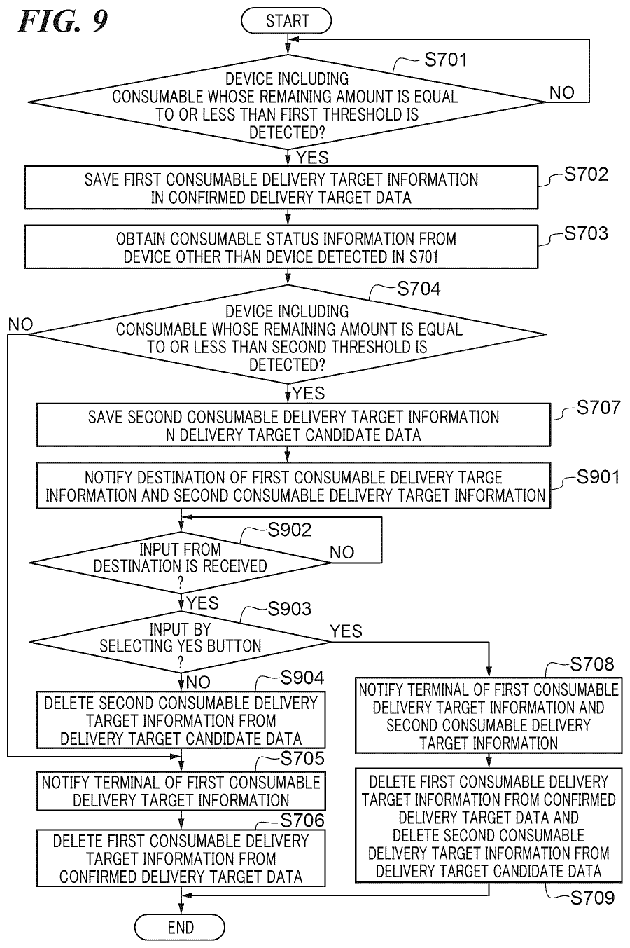

Hereinafter, a second embodiment will be described with reference to FIG. 9 to FIG. 11. The first embodiment describes the delivery management of the consumables in consideration of the case where the first threshold and the second threshold provided in each of the plurality of image processing apparatuses 103 subjected to the subscription contract are different. Accordingly, the service provider of the subscription contract can create more situations in which the consumables of the plurality of image processing apparatuses 103 are collectively delivered, and improve the efficiency of the consumable delivery.

For the consumable indicated by the second consumable delivery target information stored in the delivery target candidate data 613, that is, the consumable that is expected to reach the replacement time soon, it is desirable to display a screen that allows the user to select whether to request immediate delivery. Therefore, the second embodiment describes a screen displayed on the host terminal 104 or the like in a case where the image processing apparatus 103 including the consumable that is expected to reach the replacement time soon is detected in addition to the detection of the image processing apparatus 103 including the consumable that reaches the replacement time. The following description of the second embodiment is focused on the differences from the first embodiment.

FIG. 9 is a flowchart illustrating an operation when the server 102 performs delivery management of consumables in the second embodiment. The flowchart in FIG. 9 is achieved by the CPU 311 in the server 102 loading the program read from the storage device 314 onto the RAM 313 and executing the program. Further, the description will be made using the device A, device B, and device C as the plurality of image processing apparatuses 103. In the flowchart in FIG. 9, the steps S701 to S709 are the same as that in FIG. 7 described above. However, the CPU 311 performs a step S901 after performing the step S707 described above.

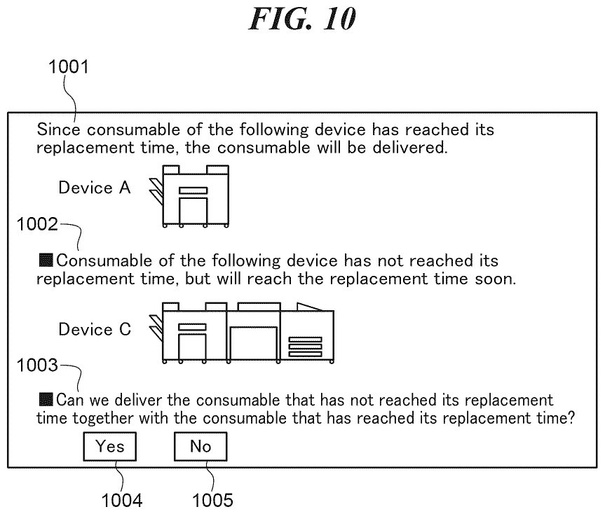

In the step S901, the CPU 311 (a notification unit) notifies a notification destination of the first consumable delivery target information saved in the confirmed delivery target data 612 and the second consumable delivery target information saved in the delivery target candidate data 613 with the network communication module 604. The notification destination in the step S901 is the host terminal 104. When receiving the notification in the step S901, the host terminal 104 displays, for example, a selection screen shown in FIG. 10 on the display 402. FIG. 10 illustrates a selection screen example that prompts an administrator who maintains the plurality of image processing apparatuses 103 subjected to the subscription contract to select whether to allow delivery of the consumable.

The selection screen example illustrated in FIG. 10 is displayed on the display 402 of the host terminal 104 in a situation in which the consumable of the device A reaches the replacement time and the consumable of the device C is expected to reach the replacement time soon, similarly to the specific examples illustrated in FIG. 8A, FIG. 8B, and FIG. 8C. In the selection screen example illustrated in FIG. 10, a message 1001 of “Since consumable of the following device has reached its replacement time, the consumable will be delivered.” is displayed together with the name and illustration of the device A as a display about the situation related to the device A.

In addition, a message 1002 of “Consumable of the following device has not reached its replacement time, but will reach the replacement time soon.” is displayed together with the name and illustration of the device C as a display of the situation related to the device C. Further, a message 1003 of “Can we deliver the consumable that has not reached its replacement time together with the consumable that has reached its replacement time?”, a Yes button 1004, and a No button 1005 are displayed. Accordingly, the host terminal 104 prompts the administrator who maintains the plurality of image processing apparatuses 103 subjected to the subscription contract to select the Yes button 1004 or the No button 1005.

Returning to the description of FIG. 9. In a step S902, the CPU 311 determines whether an input from the notification destination in the step S901 is received with the network communication module 604. When the CPU 311 determines with the network communication module 604 that no input is received from the notification destination in the step S902, the process repeats the determination in the step S902. On the other hand, when the CPU 311 determines with the network communication module 604 that the input from the notification destination is received in the step S902, the process proceeds to a step S903.

In the step S903, the CPU 311 determines with the network communication module 604 whether the input from the notification destination in the step S902 is caused by selecting the Yes button 1004. When the CPU 311 determines with the network communication module 604 that the input from the notification destination in the step S902 is caused by selecting the Yes button 1004, the steps S708 and S709 described above are executed. Accordingly, the delivery of the consumables in accordance with the subscription contract is performed based on the first consumable delivery target information and the second consumable delivery target information. Thereafter, the flowchart in FIG. 9 ends.

On the other hand, when the CPU 311 determines with the network communication module 604 that the input from the notification destination in the step S902 is not caused by selecting the Yes button 1004, the process proceeds to a step S904. That is, when the input from the notification destination in the step S902 is caused by selecting the No button 1005, the process proceeds to the step S904. In the step S904, the CPU 311 deletes with the consumable delivery information management module 605 the second consumable delivery target information saved in the delivery target candidate data 613. Thereafter, the CPU 311 (an instruction unit) performs the respective steps S705 and S706 described above. Accordingly, the delivery of the consumable in the subscription contract is performed based on the first consumable delivery target information. Thereafter, the flowchart in FIG. 9 ends.

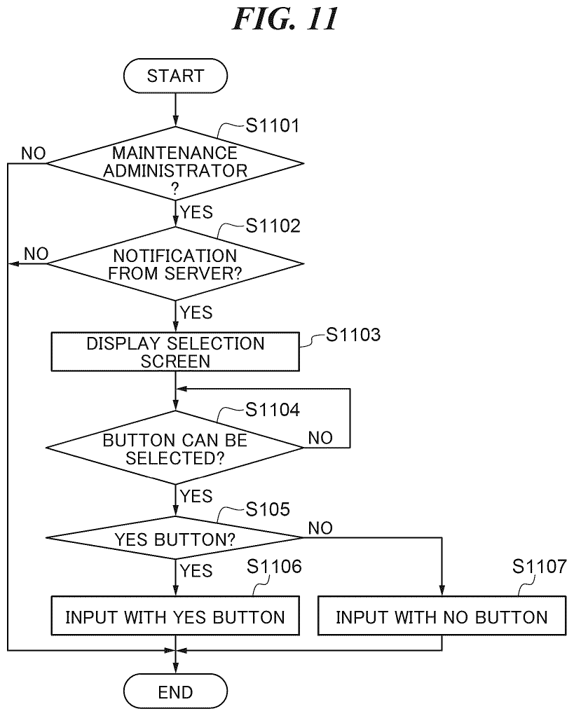

FIG. 11 is a flowchart illustrating an operation when the host terminal 104 displays the selection screen. The flowchart in FIG. 11 is achieved by the CPU 411 loading the program read from the storage device 414 onto the RAM 413 and executing the program in the host terminal 104. When the flowchart in FIG. 11 is started, the CPU 411 determines, in a step S1101, whether the operator is an administrator (hereinafter referred to as a maintenance administrator) who maintains the plurality of image processing apparatuses 103 subjected to the subscription contract. This determination is performed using authentication by a password or a PIN code, but is not limited thereto, and may be performed using, for example, two step authentication or biometric authentication. When the CPU 411 determines that the operator is not a maintenance administrator, the flowchart in FIG. 11 ends. On the other hand, when the CPU 411 determines that the operator is a maintenance administrator, the process proceeds to a step S1102.

In the step S1102, the CPU 411 determines whether there is a notification from the server 102. When the CPU 411 determines that there is no notification from the server 102, the flowchart in FIG. 11 ends. At this time, the CPU 411 may display, on the display 402, information indicating that there is no notification from the server 102. On the other hand, when the CPU 411 determines that there is a notification from the server 102, the process proceeds to a step S1103.

In the step S1103, the CPU 411 (a display unit) displays a selection screen on the display 402. Accordingly, for example, the selection screen example illustrated in FIG. 10 is displayed on the display 402. In a step S1104, the CPU 411 determines whether the Yes button 1004 or the No button 1005 can be selected. This is determined based on the information output from the operation-unit I/F 415. When the CPU 411 determines that the Yes button 1004 and the No button 1005 cannot be selected, the determination in the step S1104 is repeated. On the other hand, when the CPU 411 determines that the Yes button 1004 or the No button 1005 can be selected, the process proceeds to a step S1105.

In the step S1105, the CPU 411 determines whether the target of the determination in the step S1104 is the selection of the Yes button 1004. This is also determined based on the information output from the operation-unit I/F 415. When the CPU 411 determines that the determination target in the step S1104 is not the selection of the Yes button 1004, the process proceeds to a step S1107 described later. That is, when the determination target in the step S1104 is the selection of the No button 1005, the process proceeds to the step S1107 described later. On the other hand, when the CPU 411 determines that the determination target in the step S1104 is the selection of the Yes button 1004, the process proceeds to a step S1106.

In the step S1106, the CPU 411 (an input unit) inputs the selection of the Yes button 1004 to the server 102. Thereafter, the flowchart in FIG. 11 ends. In the step S1107, the CPU 411 (the input unit) inputs the selection of the No button 1005 to the server 102. Thereafter, the flowchart in FIG. 11 ends.

The selection screen example shown in FIG. 10 may be displayed on the display operation unit 206 of the image processing apparatus 103 (hereinafter, referred to as a representative image processing apparatus 103) (a third image processing apparatus) predetermined in the subscription contract from among the plurality of image processing apparatuses 103. For this purpose, the representative image processing apparatus 103 is notified in the step S901, and the flowchart in FIG. 11 is performed by the CPU 211 of the representative image processing apparatus 103.

In addition, the selection screen example illustrated in FIG. 10 may be displayed on the display operation units 206 of all the image processing apparatuses 103 subjected to the subscription contract. For this purpose, all the image processing apparatuses 103 are notified in the step S901. The flowchart in FIG. 11 is performed by the CPUs 211 of all the image processing apparatuses 103.

As described above, the consumable delivery management system 100 enables the selection of whether to allow delivery of the consumable that is expected to reach the replacement time soon, according to the convenience of the user using the service of the subscription contract. Accordingly, the consumable delivery management system 100 enables the delivery of the consumable in consideration of the user while improving the efficiency of the delivery management of the consumable.

In the second embodiment, there is one consumable whose remaining amount is equal to or less than the second threshold, that is, there is one consumable that is expected to reach the replacement time soon, but there may be two or more consumables. In such a case, the host terminal 104 or the image processing apparatus 103 may display a selection screen on which the selection of whether to allow delivery of two or more consumables that are expected to reach the replacement time soon can be collectively performed with the Yes button 1004 and the No button 1005.

The host terminal 104 or the image processing apparatus 103 may display a selection screen in which the Yes button 1004 and the No button 1005 are provided for each of two or more consumables that are expected to reach the replacement time soon. In this case, when the No button 1005 is selected, the host terminal 104 or the image processing apparatus 103 deletes the second consumable delivery target information indicating the consumable that is a target of the selection from the delivery target candidate data 613. As a result, the server 102 performs the step S708 when the second consumable delivery target information remains in the delivery target candidate data 613, and performs the step S705 when the second consumable delivery target information does not remain in the delivery target candidate data 613.

Note that, a case where there are two or more consumables that are expected to reach the replacement time soon is, for example, a case where there is one consumable that is expected to reach the replacement time soon in each of two or more different image processing apparatuses 103. In addition, there is a case where there are two or more consumables that are expected to reach the replacement time soon in one image processing apparatus 103.

Although the preferred embodiments of the present disclosure have been described above, the present disclosure is not limited to the above-described embodiments, and various modifications and changes can be made within the scope of the gist thereof. For example, the operations of the server 102 may be performed by one of the plurality of image processing apparatuses 103. In this case, the server 102 may be omitted.

According to the present disclosure, it is possible to improve the efficiency of the delivery management of consumables for a plurality of image processing apparatuses.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-033567, filed Mar. 4, 2025, which is hereby incorporated by reference herein in its entirety.

What is claimed is:

1. A delivery management system comprising:
a plurality of image processing apparatuses using consumables; and
a server that holds a first threshold and a second threshold larger than the first threshold provided for each of the plurality of image processing apparatuses and is capable of communicating with the plurality of image processing apparatuses, the server comprising:
a first generation unit configured to generate first information indicating a first image processing apparatus among the plurality of image processing apparatuses and a first consumable used in the first image processing apparatus in a case where a remaining amount of the first consumable becomes equal to or less than the first threshold provided for the first image processing apparatus;
a second generation unit configured to generate second information indicating a second image processing apparatus among the plurality of image processing apparatuses and a second consumable used in the second image processing apparatus in a case where the first information is generated and a remaining amount of the second consumable becomes equal to or less than the second threshold provided for the second image processing apparatus; and
an instruction unit configured to instruct delivery of the first consumable and the second consumable by using the first information and the second information,
wherein at least one of the first thresholds and the second thresholds are different among the plurality of image processing apparatuses.

2. The delivery management system according to claim 1, further comprising a host terminal capable of communicating with the plurality of image processing apparatuses and the server,
wherein the server includes a notification unit configured to notify the host terminal of the second information,
the host terminal includes a display unit configured to display a selection screen on which selection of whether to allow delivery of the second consumable can be performed using the second information, and an input unit configured to perform an input corresponding to the selection of whether to allow delivery of the second consumable on the selection screen to the server,
the instruction unit of the server instructs delivery of the first consumable and the second consumable by using the first information and the second information in a case where the input corresponding to the selection on the selection screen allows delivery of the second consumable, and instructs delivery of only the first consumable by using only the first information in a case where the input corresponding to the selection on the selection screen does not allow delivery of the second consumable.

3. The delivery management system according to claim 2, wherein the display unit of the host terminal displays a selection screen on which selection of whether to allow delivery of a plurality of second consumables is collectively performed in a case where the second information indicates the plurality of second consumables.

4. The delivery management system according to claim 2, wherein the display unit of the host terminal displays a selection screen on which selection of whether to allow delivery of a plurality of second consumables is performed for each of the plurality of the second consumables in a case where the second information indicates the plurality of second consumables, and
the instruction unit of the server instructs delivery of the second consumables according to the input corresponding to the selection of whether to allow delivery of the second consumables on the selection screen.

5. The delivery management system according to claim 2, wherein the server includes a notification unit configured to notify a third image processing apparatus among the plurality of image processing apparatuses of the second information,
the third image processing apparatus includes a display unit configured to display a selection screen on which selection of whether to allow delivery of the second consumable can be performed using the second information, and an input unit configured to perform an input corresponding to the selection of whether to allow delivery of the second consumable on the selection screen to the server,
the instruction unit of the server instructs delivery of the first consumable and the second consumable by using the first information and the second information in a case where the input corresponding to the selection on the selection screen allows delivery of the second consumable, and instructs delivery of only the first consumable by using only the first information in a case where the input corresponding to the selection on the selection screen does not allow delivery of the second consumable.

6. The delivery management system according to claim 5, wherein the display unit of the third image processing apparatus host terminal displays a selection screen on which selection of whether to allow delivery of a plurality of second consumables is collectively performed in a case where the second information indicates the plurality of second consumables.

7. The delivery management system according to claim 5, wherein the display unit of the third image processing apparatus displays a selection screen on which selection of whether to allow delivery of a plurality of second consumables is performed for each of the plurality of the second consumables in a case where the second information indicates the plurality of second consumables, and
the instruction unit of the server instructs delivery of the second consumables according to the input corresponding to the selection of whether to allow delivery of the second consumables on the selection screen.

8. The delivery management system according to claim 1, further comprising a terminal that instructs to deliver consumables used in the plurality of image processing apparatuses and is capable of communicating with the server,
wherein the instruction unit notifies the terminal of the first information and the second information.

9. The delivery management system according to claim 1, wherein all of the first thresholds and the second thresholds provided for the plurality of image processing apparatuses are mutually different.

10. The delivery management system according to claim 1, wherein all of the consumables used in the plurality of image processing apparatuses are mutually different.

11. A non-transitory computer-readable storage medium storing a delivery management program that holds a first threshold and a second threshold larger than the first threshold provided for each of a plurality of image processing apparatuses using consumables, the delivery management program causing a computer to:
generate first information indicating a first image processing apparatus among the plurality of image processing apparatuses and a first consumable used in the first image processing apparatus in a case where a remaining amount of the first consumable becomes equal to or less than the first threshold provided for the first image processing apparatus;
generate second information indicating a second image processing apparatus among the plurality of image processing apparatuses and a second consumable used in the second image processing apparatus in a case where the first information is generated and a remaining amount of the second consumable becomes equal to or less than the second threshold provided for the second image processing apparatus; and
instruct delivery of the first consumable and the second consumable by using the first information and the second information,
wherein at least one of the first thresholds and the second thresholds are different among the plurality of image processing apparatuses.

12. The non-transitory computer-readable storage medium according to claim 11, wherein the delivery management program causing the computer to:
notify the host terminal of the second information to cause the host terminal to display a selection screen on which selection of whether to allow delivery of the second consumable can be performed;
instruct delivery of the first consumable and the second consumable by using the first information and the second information in a case where an input from the host terminal corresponding to the selection on the selection screen allows delivery of the second consumable, and
instruct delivery of only the first consumable by using only the first information in a case where the input from the host terminal corresponding to the selection on the selection screen does not allow delivery of the second consumable.

13. The non-transitory computer-readable storage medium according to claim 12, wherein the delivery management program causing the computer to notify the host terminal of the second information to cause the host terminal to display a selection screen on which selection of whether to allow delivery of a plurality of second consumables is collectively performed in a case where the second information indicates the plurality of second consumables.

14. The non-transitory computer-readable storage medium according to claim 12, wherein the delivery management program causing the computer to:
notify the host terminal of the second information to cause the host terminal to display a selection screen on which selection of whether to allow delivery of a plurality of second consumables is performed for each of the plurality of the second consumables in a case where the second information indicates the plurality of second consumables, and
instruct delivery of the second consumables according to the input corresponding to the selection of whether to allow delivery of the second consumables on the selection screen.

15. The non-transitory computer-readable storage medium according to claim 11, wherein the delivery management program causing the computer to:
notify a third image processing apparatus among the plurality of image processing apparatuses of the second information to cause the third image processing apparatus to display a selection screen on which selection of whether to allow delivery of the second consumable can be performed;
instruct delivery of the first consumable and the second consumable by using the first information and the second information in a case where an input from the third image processing apparatus corresponding to the selection on the selection screen allows delivery of the second consumable, and
instruct delivery of only the first consumable by using only the first information in a case where the input from the third image processing apparatus corresponding to the selection on the selection screen does not allow delivery of the second consumable.

16. The non-transitory computer-readable storage medium according to claim 15, wherein the delivery management program causing the computer to notify the third image processing apparatus of the second information to cause the third image processing apparatus to display a selection screen on which selection of whether to allow delivery of a plurality of second consumables is collectively performed in a case where the second information indicates the plurality of second consumables.

17. The non-transitory computer-readable storage medium according to claim 15, wherein the delivery management program causing the computer to:
notify the third image processing apparatus of the second information to cause the third image processing apparatus to display a selection screen on which selection of whether to allow delivery of a plurality of second consumables is performed for each of the plurality of the second consumables in a case where the second information indicates the plurality of second consumables; and
instruct delivery of the second consumables according to the input corresponding to the selection of whether to allow delivery of the second consumables on the selection screen.

18. The non-transitory computer-readable storage medium according to claim 11, wherein the delivery management program causing the computer to notify a terminal that instructs delivery of the consumables used in the plurality of image processing apparatuses of the first information and the second information.

19. The non-transitory computer-readable storage medium according to claim 11, wherein all of the first thresholds and the second thresholds provided for the plurality of image processing apparatuses are mutually different.

20. A delivery management method performed by a server that executes a delivery management program that holds a first threshold and a second threshold larger than the first threshold provided for each of a plurality of image processing apparatuses using consumables, the delivery management method comprising:
a first generation step of generating first information indicating a first image processing apparatus among the plurality of image processing apparatuses and a first consumable used in the first image processing apparatus in a case where a remaining amount of the first consumable becomes equal to or less than the first threshold provided for the first image processing apparatus;
a second generation step of generating second information indicating a second image processing apparatus among the plurality of image processing apparatuses and a second consumable used in the second image processing apparatus in a case where the first information is generated and a remaining amount of the second consumable becomes equal to or less than the second threshold provided for the second image processing apparatus; and
an instruction step of instructing delivery of the first consumable and the second consumable by using the first information and the second information,
wherein at least one of the first thresholds and the second thresholds are different among the plurality of image processing apparatuses.
